(19) United States
(12) Patent Application Publication
(10) Pub. No.: US 2006/0165248 A1
(43) Pub. Date: Jul. 27, 2006

(54) Prefabricated speaker enclosure assembly

(75) Inventors: Peter Butcher, Simi Valley, CA (US); Joe Garretson, Simi Valley, CA (US); Jack DeBiasio, Moorpark, CA (US)

Correspondence Address: MCDERMOTT WILL & EMERY LLP, Suite 3400, 2049 Century Park East, Los Angeles, CA, 90067, US

(73) Assignee: Scosche Industries, Inc.

(21) Appl. No.: 11/041,523

(22) Filed: Jan. 24, 2005

(51) Int. Cl. H04R 1/02

(52) U.S. Cl. 381/345

(57) ABSTRACT

A method of assembling a prefabricated speaker enclosure and an assembly including left and right side panels, top, front, bottom, and rear panels each having an inner surface with a left channel configured to receive the left side panel and a right channel configured to receive the right side panel, and a continuous material extending along an outer surface of the top, front, bottom, and rear panels to form a living hinge at each point where two of the top, front, bottom, and rear panels meet.

### FIELD

This disclosure relates generally to speaker enclosures, and more particularly, to prefabricated speaker enclosure assemblies.

### BACKGROUND

In most loudspeaker systems, speakers are usually housed in a speaker enclosure. Speaker enclosures serve a number of functions. On their most basic level, they make it easier to set up the speakers. With an enclosure, all the speaker components can be kept in one unit, and placed in their respective optimal positions so as to produce a high quality sound.

It is generally known that speakers transmit sound waves by translating electrical signals into physical vibrations. To reduce undesired vibrations and maximize the sound quality, enclosures are usually built with heavy wood or other solid material that can effectively absorb the speaker's vibration. Because speakers require exterior means by which to vibrate, most speaker enclosures are designed to provide hollow space within themselves. Such design occupies a large space and becomes problematic when shipping or storing speaker enclosures.

Prefabricated speaker enclosures are designed to address the problem. However, most prefabricated speaker enclosures come in multiple pieces and/or are designed so that assembly is not intuitive to most average users. Accordingly, there is a need in the art for a prefabricated speaker enclosure that can be assembled by the end user with ease and speed.

### SUMMARY

In one aspect of the present invention, a speaker enclosure assembly includes left and right side panels, top, front, bottom, and rear panels each having an inner surface with a left channel configured to receive the left side panel and a right channel configured to receive the right side panel, and a continuous material extending along an outer surface of the top, front, bottom, and rear panels to form a living hinge at each point where two of the top, front, bottom, and rear panels meet.

In another aspect of the present invention, a speaker enclosure assembly includes left and right side panels, and a panel strip having top, front, bottom, and rear panels attached by a continuous material that forms a living hinge at each point where two of the top, front, bottom, and rear panels meet, each of the top, front, bottom, and rear panels having an inner surface with a left channel configured to receive the left side panel and a right channel configured to receive the right side panel.

In a further aspect of the present invention, a method of assembling a speaker enclosure, the speaker enclosure having left and right side panels, and a panel strip, the panel strip having top, front, bottom, and rear panels attached by a continuous material that forms a living hinge at each point where two of the top, front, bottom, and rear panels meet, each of the top, front, bottom, and rear panels having an inner surface with left and right channels, the method includes inserting the left side panel into the left channel, inserting the right side panel into the right channel, and forming the speaker enclosure by folding the panel strip at the living hinges.

It is understood that other aspects of the present invention will become readily apparent to those skilled in the art from the following detailed description, wherein various embodiments of the invention are shown and described by way of illustration. As will be realized, the invention is capable of other and different embodiments and its several details are capable of modification in various other respects, all without departing from the spirit and scope of the present invention. Accordingly, the drawings and detailed description are to be regarded as illustrative in nature and not as restrictive.

### BRIEF DESCRIPTION OF DRAWINGS

Referring to the drawings, wherein like reference numerals indicate like parts throughout the several views, the several aspects of the invention are illustrated by way of example, and not by way of limitation, in detail in the figures, wherein:

FIG. 1 is an exploded perspective view of the prefabricated speaker enclosure.

FIG. 2 is a perspective view of an assembled speaker enclosure.

FIG. 3 is a perspective view of a speaker enclosure being assembled.

### DETAILED DESCRIPTION OF ILLUSTRATIVE EMBODIMENTS

The detailed description set forth below in connection with the appended drawings is intended as a description of various embodiments of the present invention and is not intended to represent the only embodiments described herein. The detailed description includes specific details for the purpose of providing a comprehensive understanding of the present invention. However, it will be apparent to those skilled in the art that the present invention may be practiced without these specific details.

The present prefabricated speaker enclosure is designed to facilitate effective shipping and storage. A prefabricated speaker enclosure comes partially assembled in an unfolded manner so as to increase the surface area in a given space. It allows enclosures to stack on top of each other, increasing the surface area/volume ratios. Accordingly, the prefabricated design allows a larger number of speaker enclosures to be shipped and stored in a given space.

Further, the prefabricated speaker enclosure is designed so that the end user can assemble it with ease and speed. The present invention has a minimum number of parts necessary to assemble a speaker enclosure. Each part is designed so that assembly is simple and self-evident.

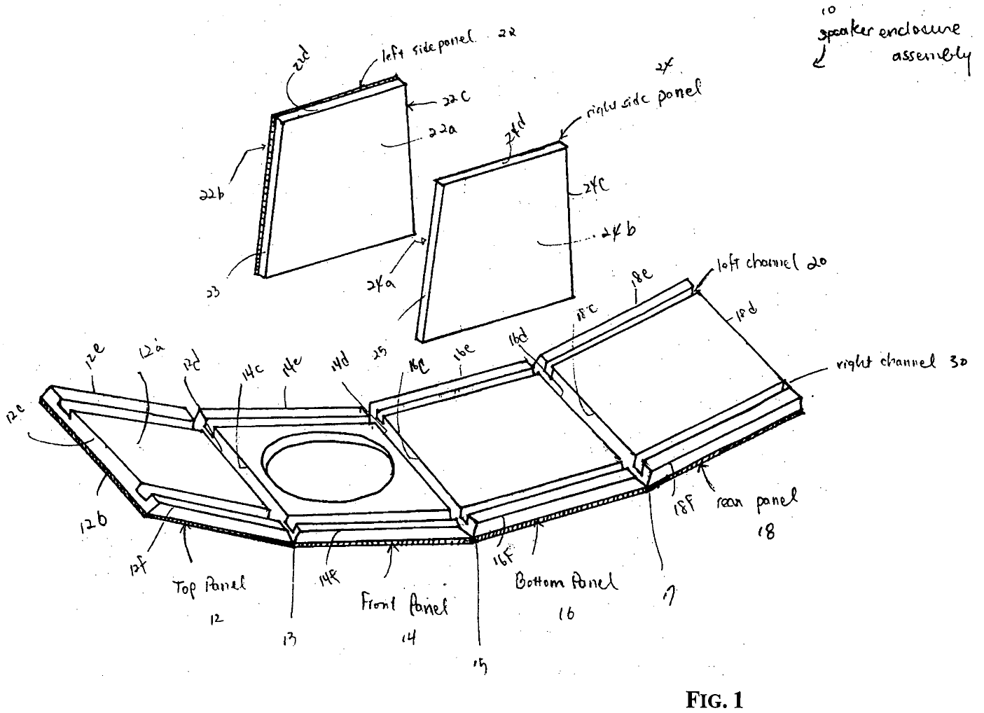

Various embodiments of a prefabricated speaker enclosure will now be described. As shown in FIG. 1, the speaker enclosure assembly 10 may include a left side panel 22, a right side panel 24, a top panel 12, a front panel 14, a bottom panel 16, and a rear panel 18. Through a continuous material 40 that extends along the outer surfaces of the panels 12b, 14b, 16b, 18b, the top 12, front 14, bottom 16, and rear 18 panels may come in one panel strip 100.

The continuous material 40 may be designed so as to form a number of living hinges. A first living hinge 13 may be at a point where the top panel 12 and the front panel 14 meet; a second living hinge 15 may be at a point where the front panel 14 and the bottom panel 16 meet; and a third living hinge 17 may be at a point where the bottom panel 16 and the rear panel 18 meet.

The continuous material 40 can be made of any material that allows formation of the living hinges 13, 15, 17. Such materials may include, but not limited to, carpet, rubber, and plastic. It may be that the end user wishes to match the material 40 of his/her speaker enclosure with the environment in which the enclosure will be placed. For example, if the speaker is to be used in an automobile trunk, the end user may wish to have a carpeted material on his/her speaker enclosure to match the carpet on the trunk of his/her car. Other users may wish to have plastic material for aesthetic reasons or rubber material for additional water resistance.

On the inner surface 12a, 14a, 16a, 18a of the top 12, front 14, bottom 16, and rear 18 panels, a channel 20 may run longitudinally along the length of the panel strip 100 near one edge 12e, 14e, 16e, 18e. The channel 20 may be designed to receive the left side panel 22. A similar channel 30 may be constructed to receive the right side panel 24 near the opposite edge 12f, 14f, 16f, 18f.

The left and right side panels 22, 24 may each have at least one tapered edge 23, 25, respectively. The left channel 20 in the front panel 14 may be configured to receive the tapered edge 23 of the left side panel 22, and the right channel 30 in the front panel 14 may be configured to receive the tapered edge 25 of the right side panel 24.

Each of the top 12, front 14, bottom 16, and rear 18 panels may have first and second edges. The top panel 12 may have a first edge 12c which may substantially be in contact with the second edge 18d of the rear panel 18 once the panel strip 100 is folded at the living hinges 13, 15, 17. Similarly, the second edge 12d of the top panel 12 may substantially be in contact with the first edge 14c of the front panel 14; the second edge 14d of the front panel 14 may substantially be in contact with the first edge 16c of the bottom panel 16; and the second edge 16d of the bottom panel 16 may substantially be in contact with the first edge 18c of the rear panel 18.

The first and second edges of each panel may be substantially perpendicular to their respective left 20 and right 30 channels and have an outward taper extending from its respective inner surface to its respective outer surface. For example, the first edge 12c of the top panel 12 may have an outward taper extending from the inner surface 12a of the top panel 12 to its outer surface 12b. Similarly, the first edge 14c of the front panel 14 may have an outward taper extending from the inner surface 14a of the front panel 14 to its outer surface 14b, and the first edge 16c of the bottom panel 16 may have an outward taper extending from the inner surface 16a of the bottom panel 16 to its outer surface 16b. Finally, the first edge of 18c of the rear panel 18 may have an outward taper extending from the inner surface 18a of the rear panel 18 to its outer surface 18b. Accordingly, it may be that the inner surface area of the top 12, front 14, bottom 16, and rear 18 panels is smaller than the surface area of their respective outer surfaces.

It may be that the front panel 14 has a hole to accommodate a speaker (not shown) and a grill (not shown).

As additional security, the channels 20, 30 may be pre-disposed to an adhesive material, such as a strip of adhesive tape or glue. When securing the left 22 and right 24 side panels in the left 20 and right 30 channels, the end use may apply an adhesive material in the left channel 20 and the right channel 30 before inserting the left 22 and right 24 side panels in the left 20 and right 30 channels and folding the panel 100 at the living hinges 13, 15, 17. The adhesive material may include, but not limited to, a strip of adhesive tape or glue.

In an embodiment where an adhesive tape is used, such tape may be double-sided with its adhesive coating exposed only after its release liner is peeled off. One side of the double-sided adhesive tape may be mounted to the channels 20, 30, while the other side still has its release liner intact. The end user may simply peel off the release liner on the other side of the double-sided adhesive tape just before assembling the speaker enclosure.

Double-sided adhesive tape may also be mounted inside the living hinges 13, 15, 17. For example, a strip of double-sided adhesive tape may be mounted to the second edge 12d of the top panel 12 and/or to the first edge 14c of the front panel 14, so that when the second edge 12d and the first edge 14c come substantially close to be in contact, the tape may provide additional security. Similarly, a strip of double-sided adhesive tape may be mounted to the second edge 14d of the front panel 14 and/or the first edge 16c of the bottom panel 16. When the second edge 14d and the first edge 16c come substantially close to be in contact, the tape may provide additional security. Finally, a strip of double-sided adhesive tape may be mounted to the second edge 16d of the bottom panel 16 and/or the first edge 18c of the rear panel 18. When the second edge 16d and the first edge 18c come substantially close to be in contact, the tape may provide additional security.

Further, a strip of double-sided adhesive tape may be mounted to the second edge 18d of the rear panel 18 and/or the first edge 12c of the top panel 12. When the second edge 18d and the first edge 12c come substantially close to be in contact, the tape may provide additional security.

To provide additional security, the end user may use fastening materials, including, but not limited to, nuts and bolts, nails.

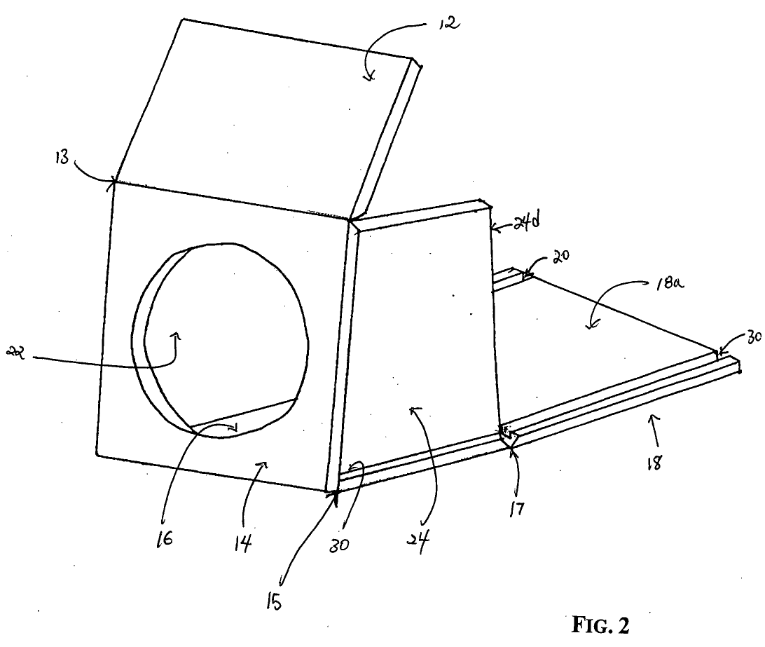

FIG. 2 shows the assembly in process. In FIG. 2, The left side panel 22 and right side panel 24 have been already inserted into the left 20 and right 30 channels of the bottom panel 16, respectively. Further, the panel strip 100 has been folded at the second living hinge 15 where the front panel 14 and the bottom panel 16 meet, bringing the second edge 14d of the front panel 14 substantially in contact with the first edge 16c of the bottom panel 16.

FIG. 2 further depicts the panel strip 100 in motion to complete the folding at the first living hinge 13, where the top panel 12 and the front panel 14 meet. The folding at the first living hinge 13 may bring the second edge 12d of the top panel 12 substantially in contact with the first edge 14c of the front panel 14. Further, the left 20 and right 30 channels on the inner surface 12a of the top panel 12 may receive the left 22 and right 24 side panels, respectively. Specifically, the left channel 20 on the inner surface 12a of the top panel 12 may receive the top edge 22d of the left side panel 22. Similarly, the right channel 30 on the inner surface 12a of the top panel 12 may receive the top edge 24d of the right side panel 24.

The assembly may be completed by folding the panel strip 100 at the third living hinge 17 where the bottom panel 16 and the rear panel 18 meet. The folding at the third living hinge 17 may bring the second edge 18d of the rear panel 18 substantially in contact with the first edge 12c of the top panel 12. Further, the left 20 and right 30 channels on the inner surface 18a of the rear panel 18 may receive the left 22 and right 24 side panels, respectively. Specifically, the left channel 20 on the inner surface 18a of the rear panel 18 may receive the rear edge 22c of the left side panel 22. Similarly, the right channel 30 on the inner surface 18a of the rear panel 18 may receive the top edge 24d of the right side panel 24.

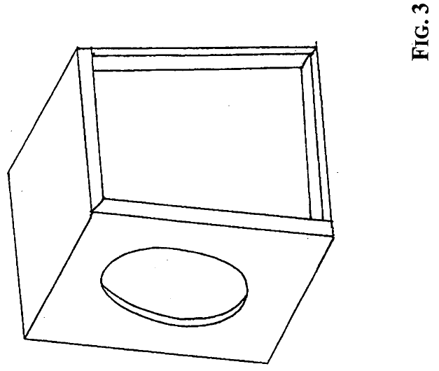

FIG. 3 shows an speaker enclosure after the assembly is completed.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

We claim:

1. A speaker enclosure assembly, comprising:
first and second side panels;
top, front, bottom, and rear panels each having an inner surface with a first channel configured to receive the first side panel and a second channel configured to receive the second side panel; and
a continuous material extending along an outer surface of the top, front, bottom, and rear panels to form a living hinge at each point where two of the top, front, bottom, and rear panels meet;

2. The speaker enclosure assembly of claim 1 wherein the first and second side panels each comprises a tapered edge.

3. The speaker enclosure assembly of claim 2 wherein the first channel in the rear panel is configured to receive the tapered edge of the first side panel, and the second channel in the rear panel is configured to receive the tapered edge of the second side panel.

4. The speaker enclosure assembly of claim 1 wherein each of the top, front, bottom, and rear panels has its first channel extending along an edge and its second channel extending along an opposite edge.

5. The speaker enclosure assembly of claim 1 wherein each of the top, front, bottom, and rear panels comprises a first adhesive tape strip disposed in its respective first channel and a second adhesive tape strip disposed in its respective second channel.

6. The speaker enclosure assembly of claim 1 wherein each of the top, front, bottom, and rear panels comprises opposite edges substantially perpendicular to the its respective first and second channels, each of the edges having an outward taper extending from its respective inner surface to its respective outer surface.

7. The speaker enclosure assembly of claim 1 wherein the continuous material comprises carpet.

8. The speaker enclosure assembly of claim 1 wherein a first one of the living hinges is formed between the front and bottom panel, a second one of the living hinges is formed between the bottom and the rear panel, and a third one of the living hinges is formed between the rear and top panel.

9. The speaker enclosure assembly of claim 1 further comprising a speaker and grill, the front panel having a hole to accommodate the speaker and the grill.

10. A speaker enclosure assembly, comprising:
first and second side panels; and
a panel strip having top, front, bottom, and rear panels attached by a continuous material that forms a living hinge at each point where two of the top, front, bottom, and rear panels meet, each of the top, front, bottom, and rear panels having an inner surface with a first channel configured to receive the first side panel and a second channel configured to receive the second side panel.

11. The speaker enclosure assembly of claim 10 wherein the first and second side panels each comprises a tapered edge.

12. The speaker enclosure assembly of claim 11 wherein the first channel in the rear panel is configured to receive the tapered edge of the first side panel, and the second channel in the rear panel is configured to receive the tapered edge of the second side panel.

13. The speaker enclosure assembly of claim 10 wherein each of the top, front, bottom, and rear panels has its first channel extending along an edge and its second channel extending along an opposite edge.

14. The speaker enclosure assembly of claim 10 wherein each of the top, front, bottom, and rear panels comprises a first adhesive tape strip disposed in its respective first channel and a second adhesive tape strip disposed in its respective second channel.

15. The speaker enclosure assembly of claim 10 wherein each of the top, front, bottom, and rear panels comprises opposite edges substantially perpendicular to the its respective first and second channels, each of the edges having an outward taper extending from its respective inner surface to its respective outer surface.

16. The speaker enclosure assembly of claim 10 wherein the continuous material comprises carpet.

17. The speaker enclosure assembly of claim 10 further comprising a speaker and grill, the front panel having a hole to accommodate the speaker and the grill.

18. A method of assembling a speaker enclosure, the speaker enclosure having first and second side panels, and a panel strip, the panel strip having top, front, bottom, and rear panels attached by a continuous material that forms a living hinge at each point where two of the top, front, bottom, and rear panels meet, each of the top, front, bottom, and rear panels having an inner surface with first and second channels, the method comprising:
inserting the first side panel into one of the first channels;
inserting the second side panel into one of the second channels; and
forming the speaker enclosure by folding the panel strip at the living hinges.

19. The method of claim 18 wherein the first and second side panels are inserted into their respective first and second channels in the same one of the front, rear, top or bottom panel.

20. The method of claim 19 wherein the first and second side panels are inserted into their respective first and second channels in the bottom panel.

21. The method of claim 20 wherein the speaker enclosure is formed by folding the rear panel to the back of the side panels, folding the front panel to the front of the side panels, and folding the top panel to the top of the side panels.

22. The method of claim 18 further comprising installing a speaker and grill on the front panel.

23. The method of claim 18 further comprising using a first adhesive tape strip to insert the first side panel into said one of the first channels, and using a second adhesive tape strip to insert the second side panel into said one of the second channels.

24. The method of claim 18 wherein the continuous material comprises carpet.

25. The method of claim 18 wherein the first and second side panels each comprises a tapered edge.

26. The method of claim 25 wherein the speaker enclosure is formed by receiving the tapered edge of the first side panel in the first channel of the rear panel, and receiving the tapered edge of the second side panel in the second channel of the rear panel.
